(19) United States
(12) Patent Application Publication
(10) Pub. No.: US 2026/0302900 A1
(43) Pub. Date: Oct. 1, 2026

(54) ACTUATOR ASSEMBLY WITH THROUGH-BORE RING CONTACTS AND RELATED TECHNOLOGY

(71) Applicant: Agility Robotics, Inc., Pittsburgh, PA (US)

(72) Inventors: Parker Greene, Salem, OR (US); Kevin Sweeney, Albany, OR (US)

(21) Appl. No.: 19/292,671

(22) Filed: Aug. 6, 2025

Related U.S. Application Data
(60) Provisional application No. 63/778,286, filed on Mar. 26, 2025.

(51) Int. Cl. H02K 13/04; H02K 7/116; H02K 13/00

(52) U.S. Cl. CPC H02K 13/04; H02K 7/116; H02K 13/006

(57) ABSTRACT

An actuator assembly in accordance with at least some embodiments of the present technology includes a motor having a rotor and a stator defining an annular gap therebetween. The motor is configured to rotate the rotor relative to the stator about an axis. The actuator assembly further includes gearing operably associated with the motor. The actuator assembly still further includes a ring assembly including ring contacts extending circumferentially around the axis in different respective planes perpendicular to the axis. The ring assembly also includes a first body carrying the ring contacts, leads in series with the ring contacts, and a second body carrying the leads. Finally, the ring assembly includes connectors configured to provide electrical connections between the ring contacts and the leads, respectively, during relative rotation between the first and second bodies. The actuator assembly defines a channel in which the ring assembly is at least partially disposed.

### CROSS-REFERENCE TO RELATED APPLICATION

This claims the benefit of U.S. Provisional Application No. 63/778,286, filed Mar. 26, 2025. The foregoing application is incorporated herein by reference in its entirety. To the extent the foregoing application or any other material incorporated by reference conflicts with the present disclosure, the present disclosure controls.

### TECHNICAL FIELD

The present technology relates to actuator assemblies, such as robot actuator assemblies.

### BACKGROUND

Much of the work that humans currently perform is amenable to automation using robotics. For example, large numbers of human workers currently focus on executing actions that require little or no reasoning, such as predefined relocations of items and containers at order-fulfillment centers. Such actions may occur millions of times a day at a single order-fulfillment center and billions of times a day across a network of order-fulfillment centers. Human effort would be better applied to more complex tasks, particularly those involving creativity, advanced problem solving, and social interaction. Presently, however, the need for order-fulfillment centers is large and rapidly increasing. Some analysts forecast a shortage of a million or more workers to staff order-fulfillment centers within the next ten to fifteen years. Due to the importance of this field, even small improvements in efficiency can have major impacts on macroeconomic productivity. For at least these reasons, there is a significant and growing need for innovation that supports automating tasks that humans currently perform at order-fulfillment centers and elsewhere.

### BRIEF DESCRIPTION OF THE DRAWINGS

Certain aspects of the present technology can be better understood with reference to the following drawings. The relative dimensions in the drawings may be to scale with respect to some embodiments of the present technology. With respect to other embodiments, the drawings may not be to scale. The drawings may also be enlarged arbitrarily. For clarity, reference-number labels for analogous components or features may be omitted when the appropriate reference-number labels for such analogous components or features are clear in the context of the specification and all of the drawings considered together. Furthermore, the same reference numbers may be used to identify analogous components or features in multiple described embodiments.

FIG. 1 is a perspective view of an actuator assembly in accordance with at least some embodiments of the present technology.

FIG. 2 is a front profile view of the actuator assembly of FIG. 1.

FIG. 3 is a cross-sectional view of the actuator assembly of FIG. 1 taken along the line A-A in FIG. 2.

FIG. 4 is a partially cross-sectional view of a ring assembly of the actuator assembly of FIG. 1.

FIG. 5 is a block diagram corresponding to a mobile robot including an actuator assembly in accordance with at least some embodiments of the present technology.

FIG. 6 is a block diagram corresponding to a method involving an actuator assembly in accordance with at least some embodiments of the present technology.

### DETAILED DESCRIPTION

Robots perform mechanical work via actuators. A typical actuator in an electromechanical robot includes a motor and gearing operably associated with one another. The motor includes a rotor and a stator. It consumes electricity from a power source to rotate the rotor relative to the stator about an axis at high speed and low torque. A transfer structure then transfers this torque from the rotor to the gearing. The gearing decreases the speed and increases the torque, thereby causing an output from the actuator to be suitable for a controlled mechanical action, such as moving a link relative to another link via a joint. One common technical challenge in actuator technology is compactness. In many cases, it is desirable for a powerful actuator to fit into a relatively small space. Another common technical challenge is electrical connectivity across joints. For example, it is common for a power source and a power-consuming device in a robot to be at different respective positions along a kinematic chain with multiple joints therebetween. Similarly, a sensor that collects data and a destination for that data may be at different respective positions along a kinematic chain with multiple joints therebetween. Moving power and data across intervening joints in these and other cases can present challenges.

In a joint with a limited range of motion, flexible wiring may accommodate relative rotation fairly effectively. In a joint with a large range of motion or a joint that allows unrestricted relative rotation, however, flexible wiring is typically unsuitable. For example, in a joint that allows unrestricted relative rotation, flexible wiring spanning the joint would twist and bind during normal operation. One solution to this problem is to incorporate a ring assembly at the joint. In a ring assembly, sliding or rolling electrical interfaces allow for unrestricted relative rotation without wire twisting. Ring assemblies, however, present other challenges. Ring assemblies, for example, tend to be relatively large and, therefore, undermine compactness. In a conventional actuator assembly with a ring assembly, the motor, the gearing, and the ring assembly are at different respective positions along the associated axis of rotation. Wiring passes to the ring assembly via a channel extending through the motor and the gearing along the axis of rotation. In these cases, the presence of the ring assembly can increase the overall axial extent of the actuator assembly significantly, such as by 20% or more. This impact can be limited to some extent by use of a pancake ring assembly including concentric ring contacts in a single plane perpendicular to the axis of rotation. Pancake ring assemblies, however, tend to be less reliable and less durable than cylindrical ring assemblies. Furthermore, although typically less than cylindrical ring assemblies, pancake ring assemblies still require significant volume in the axial dimension.

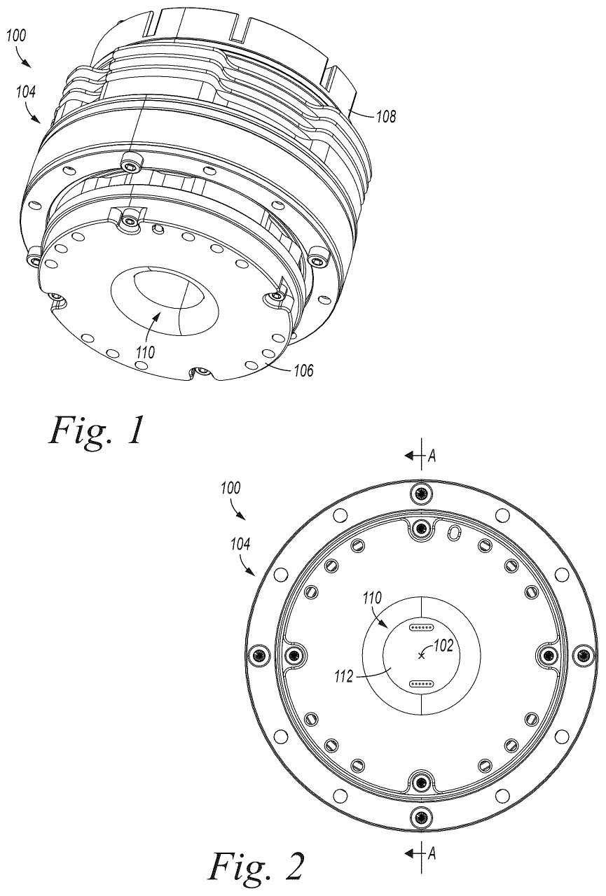

Actuator assemblies in accordance with at least some embodiments of the present technology at least partially address the foregoing and/or other disadvantages of conventional technologies. In an example, an actuator assembly in accordance with at least some embodiments of the present technology includes a cylindrical ring assembly within a through bore of the actuator assembly rather than adjacent to the through bore. Correspondingly, the ring assembly and the motor and/or the ring assembly and the gearing can share space rather than stack in the axial dimension. This configuration can allow an actuator assembly including a ring assembly to be relatively compact axially without sacrificing performance. The foregoing and other features of devices, systems, and methods in accordance with various embodiments of the present technology are further described below with reference to FIGS. 1-7. Although methods, devices, and systems may be described herein primarily or entirely in the context of actuator assemblies of mobile robots, other contexts are within the scope of the present technology. For example, suitable features of described methods, devices, and systems can be implemented in the context of stationary robots or in non-robot contexts, such as vehicles, pumps, winches, etc. Furthermore, it should be understood, in general, that other methods, devices, and systems in addition to those disclosed herein are within the scope of the present technology. For example, methods, devices, and systems in accordance with embodiments of the present technology can have different and/or additional configurations, components, procedures, etc. than those disclosed herein. Moreover, methods, devices, and systems in accordance with embodiments of the present technology can be without one or more of the configurations, components, procedures, etc. disclosed herein without deviating from the present technology.

### Examples of Actuator Assemblies

FIG. 1 is a perspective view of an actuator assembly 100 in accordance with at least some embodiments of the present technology. FIG. 2 is a front profile view of the actuator assembly 100. With reference to FIGS. 1 and 2 together, the actuator assembly 100 can define an axis 102 and can include a housing 104 having a first end portion 106 and a second end portion 108 opposite to the first end portion 106 along the axis 102. The actuator assembly 100 can further define a channel 110 extending along the axis 102 between the first end portion 106 and the second end portion 108 of the housing 104. The actuator assembly 100 also includes a ring assembly 112 at least partially disposed within the channel 110.

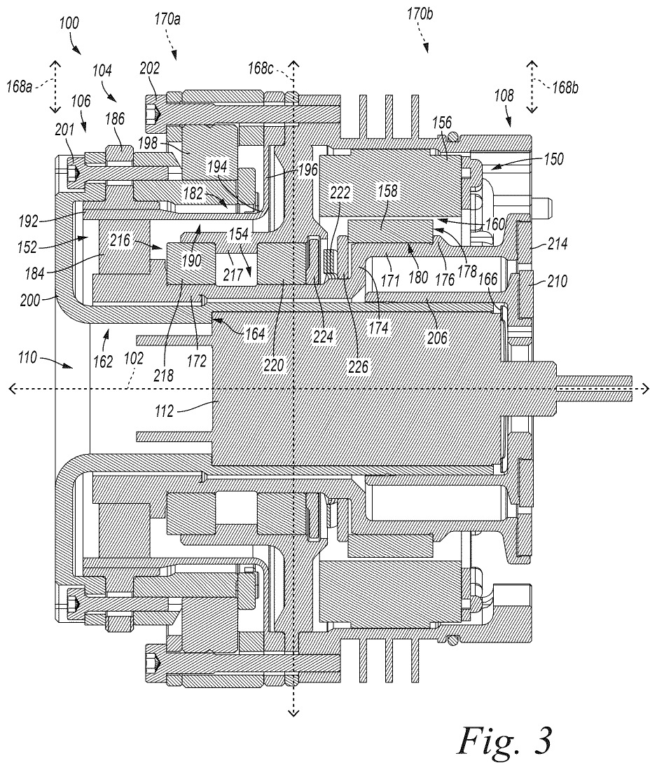

FIG. 3 is a cross-sectional view of the actuator assembly 100 taken along the line A-A in FIG. 2. For simplicity, internal components of major structures of the actuator assembly 100 are not shown. With reference now to FIGS. 1-3 together, the actuator assembly 100 can include a motor 150, gearing 152, and a shaft 154 operably associated with one another. The motor 150 can include a stator 156 and a rotor 158 in a coaxial configuration with the rotor 158 nested at least partially within the stator 156. In at least some cases, the stator 156 and the rotor 158 are annular in a plane perpendicular to the axis 102. The motor 150 can be configured to rotate the rotor 158 relative to the stator 156 about the axis 102. The rotor 158 and the stator 156 can define an annular gap 160 therebetween. The housing 104 can include a tubular shaft 162 defining the channel 110. In at least some cases, the tubular shaft 162 includes a ledge 164 abutting the ring assembly 112. Relatedly, the actuator assembly 100 can include a spring 166 also abutting the ring assembly 112. In the illustrated case, the spring 166 is a wave spring. In other embodiments, a counterpart of the spring 166 can have another suitable form. For example, a counterpart of the spring 166 can be a coil spring, a Belleville washer, etc.

As shown in FIG. 3, the actuator assembly 100 can define planes 168a-168c perpendicular to the axis 102. The actuator assembly 100 can also define regions 170a, 170b between different respective pairs of the planes 168a-168c. In particular, the planes 168a, 168b can be at the first end portion 106 of the housing 104 and at the second end portion 108 of the housing 104, respectively. The plane 168c can be equidistant between the first and second planes 168a, 168b. The region 170a can be between the plane 168a and the plane 168c. The region 170b can be between the plane 168b and the plane 168c. In at least some cases, the rotor 158 and the stator 156 are at the region 170b while the gearing 152 is at the region 170a.

The actuator assembly 100 can be configured to transfer torque from the rotor 158 to the gearing 152 via the shaft 154. The shaft 154 can be stepped. For example, the shaft 154 can include a wide portion 171, a narrow portion 172, and a step 174 therebetween. The shaft 154 can further include a stop 176 at its wide portion 171. The stop 176 can extend outwardly relative to the axis 102. The rotor 158 and the shaft 154 can contact one another via two distinct interfaces. For example, the rotor 158 can include a first surface 178 through which it directly contacts the stop 176 and a second surface 180 through which it directly contacts a portion of the shaft 154 adjacent to the stop 176. The first and second surfaces 178, 180 can be perpendicular to one another. Furthermore, the first and second surfaces 178, 180 can be perpendicular to and parallel to the axis 102, respectively. In at least some cases, a connection between the rotor 158 and the shaft 154 at the second surface 180 is a glueless connection. In addition or alternatively, this connection can be a press-fit connection, such as a thermal press-fit connection.

In the illustrated case, the gearing 152 is strain-wave gearing. The gearing 152 can include a flexspline 182, a wave generator 184 (shown integral with the shaft 154), and a circular spline 186 operably associated with one another. The shaft 154 can carry the wave generator 184 via fasteners (not shown). The flexspline 182 can include a collar 190 having a first end portion 192 and a second end portion 194 spaced apart from one another in a dimension parallel to the axis 102. The flexspline 182 can also include a flange 196 that extends radially outward from the second end portion 194 of the collar 190. At the first end portion 192 of the collar 190, the flexspline 182 can include teeth (not labeled) that interact with complementary teeth (also not labeled) of the circular spline 186. The wave generator 184 can deform the first end portion 192 of the collar 190 from within into an ellipse such that the complementary teeth of the flexspline 182 and the circular spline 186 engage at opposite ends of a major axis of the ellipse. Circumferential migration of this engagement about the axis 102 as the wave generator 184 rotates within the collar 190 then causes relative rotation between the flexspline 182 and the circular spline 186 about the axis 102 at an output torque and speed.

With continued reference to FIGS. 1-3 together, the actuator assembly 100 can include a dual angular roller bearing 198 that facilitates the relative rotation between the flexspline 182 and the circular spline 186. In another embodiment, the dual angular roller bearing 198 can be replaced with a crossed roller bearing. With reference again to the illustrated embodiment, the actuator assembly 100 can further include a cap 200 and threaded fasteners 201 (one labeled) through which the cap 200 is connected to the circular spline 186 and to the dual angular roller bearing 198. The actuator assembly 100 can also include threaded fasteners 202 (one labeled) that connect the dual angular roller bearing 198 to the housing 104 and to the flexspline 182 via the flange 196. The cap 200 can be connected to the tubular shaft 162 at the first end portion 106 of the housing 104. The actuator assembly 100 can further include a target carrier 206 coaxially nested with and secured to the tubular shaft 162, such as by gluing and/or press-fitting. The actuator assembly 100 can include an encoder target 210 at a portion of the target carrier 206 farthest from the cap 200. Similarly, the actuator assembly 100 can include another encoder target 214 carried by the shaft 154 at a portion of the shaft 154 farthest from the cap 200. In at least some cases, the encoder targets 210, 214 serve as output and input encoder targets, respectively. Furthermore, the actuator assembly 100 can include one or more sensors (not shown) configured to measure respective circumferential positions of the encoder targets 210, 214 in association with monitoring and controlling operation of the actuator assembly 100.

The actuator assembly 100 can further include an annular bearing assembly 216 configured to facilitate relative rotation about the axis 102 between the shaft 154 and the housing 104. The housing 104 can include an internal flange 217 adjacent to the annular bearing assembly 216. The annular bearing assembly 216 can be disposed between the internal flange 217 and the narrow portion 172 of shaft 154. Furthermore, the annular bearing assembly 216 can be an angular contact annular bearing assembly. This type of annular bearing assembly can be useful, for example, because the gearing 152 may generate relatively large axial loads in both directions during operation. Angular contact annular bearing assemblies are well suited to resisting these loads, thereby enhancing the stiffness of the actuator assembly 100. Correspondingly, the annular bearing assembly 216 may call for axial preloading to hold its constituent parts together. Alternatively, a counterpart of the annular bearing assembly 216 can be another suitable type that calls for axial preloading. With reference again to the illustrated embodiment, the annular bearing assembly 216 can include a first angular contact annular bearing subassembly 218 and a second angular contact annular bearing subassembly 220 axially spaced apart from one another. The first angular contact annular bearing subassembly 218 can include a first array of ball bearings (not shown) circumferentially distributed about the axis 102. Similarly, the second angular contact annular bearing subassembly 220 can include a second array of ball bearings (also not shown) circumferentially distributed about the axis 102. In at least some cases, the first and second angular contact annular bearing subassemblies 218, 220 are arranged in an “O” configuration.

The actuator assembly 100 can further include a spring 222 configured to exert first axial force on the stop 176 via the rotor 158 in a first direction parallel to the axis 102 and configured to exert second axial force on the annular bearing assembly 216 in a second direction opposite to the first direction. In some cases, the spring 222 is axially disposed between the annular bearing assembly 216 and the rotor 158. In other cases, the spring 222 can be axially disposed between the annular bearing assembly 216 and the wave generator 184. Furthermore, in the illustrated case, the spring 222 is a wave spring. The actuator assembly 100 can include spacers 224, 226 at opposite respective sides of the spring 222 in a dimension parallel to the axis 102. In other embodiments, a counterpart of the spring 222 can have another suitable form. For example, a counterpart of the spring 222 can be a coil spring, a Belleville washer, etc. Furthermore, one or both of the spacers 224, 226 can be omitted depending on the form of a counterpart of the spring 222. Furthermore, although the gearing 152 in the illustrated embodiment is strain-wave gearing, it should be understood that counterpart gearing in another embodiment can be cycloidal gearing, planetary gearing, or gearing of another suitable type.

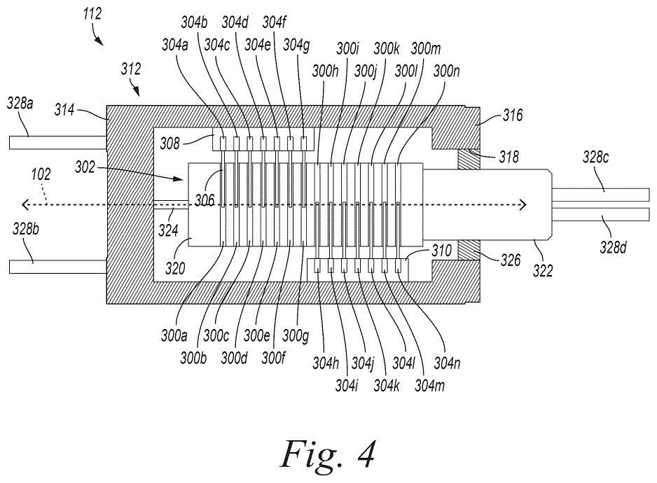

FIG. 4 is a partially cross-sectional view of the ring assembly 112. As shown in FIG. 4, the ring assembly 112 can include ring contacts 300 (individually identified as ring contacts 300a-300n) extending circumferentially around the axis 102 in different respective planes perpendicular to the axis 102. In at least some cases, the ring assembly 112 includes at least ten constituent ring contacts 300. The actuator assembly 100 can further include a cylindrical body 302 carrying the ring contacts 300. The actuator assembly 100 can also include leads 304 (individually identified as leads 304a-304n) and connectors 306 (one labeled) operably associated with the ring contacts 300. The leads 304a-304n can be electrically in series with the ring contacts 300a-300n, respectively. The actuator assembly 100 can include another body 308 carrying the leads 304a-304g and yet another body 310 carrying the leads 304h-304n. In at least some cases, the bodies 308, 310 are blocks offset from the cylindrical body 302 in opposite respective directions relative to the axis 102.

The connectors 306 can be configured to provide electrical connections between the ring contacts 300a-300n and the leads 304a-304n, respectively, during relative rotation between the cylindrical body 302 and the bodies 308, 310. In the illustrated embodiment, the connectors 306 are brushes. Correspondingly, the connectors 306 can be configured to provide sliding electrical connections between the ring contacts 300a-300n and the leads 304a-304n, respectively, during relative rotation between the cylindrical body 302 and the bodies 308, 310. In another embodiment, counterparts of the connectors 306 can be rollers configured to provide rolling electrical connections between the ring contacts 300a-300n and the leads 304a-304n, respectively, during relative rotation between the cylindrical body 302 and the bodies 308, 310.

With reference again to the illustrated embodiment, the ring assembly 112 can further include a case 312 in which the ring contacts 300, the cylindrical body 302, the leads 304, the connectors 306, and the bodies 308, 310 are disposed. The case 312 can include a first end portion 314 and a second end portion 316 opposite to one another along the axis 102. At the second end portion 316, the case 312 can include an opening 318. The cylindrical body 302 can include a main portion 320 within the case 312, and a stepped-down portion 322 that extends from the case 312 via the opening 318. The ring assembly 112 can include an axle 324 extending between the first end portion 314 of the case 312 and the main portion 320 of the cylindrical body 302. The ring assembly 112 can further include a ring bearing 326 at the opening 318. The cylindrical body 302 can be rotatably secured to the case 312 via the axle 324 at the first end portion 314 of the case 312 and via the ring bearing 326 at the second end portion 316 of the case 312. The ring assembly 112 can also include wires 328a, 328b extending from the case 312 in a direction along the axis 102 and wires 328c, 328d extending from the stepped-down portion 322 of the cylindrical body 302 in an opposite direction along the axis 102. In the context of the overall actuator assembly 100, the first wiring including the wires 328a, 328b can be at the first end portion 314 of the housing 104 and second wiring including the wires can be at the first end portion 314 of the housing 104 and the second end portion 316 of the housing 104, respectively. The first and second wiring can be electrically connected to one another via the ring assembly 112.

As shown in FIG. 3 with reference to FIG. 4, the case 312 can be axially captured between the ledge 164 and the spring 166. The ledge 164 can abut the case 312 at the region 170a of the actuator assembly 100. The spring 166 can abut the case 312 at the region 170b of the actuator assembly 100. A plane perpendicular to the axis 102 can extend through the annular gap 160 and through a given one of the ring contacts 300. In the illustrated embodiment, all of the ring contacts 300 are at the region 170b of the actuator assembly 100. In another embodiment, some of the ring contacts 300 may be at the region 170a. For example, In a counterpart of the actuator assembly 100, the ring contacts 300 can include at least five constituent ring contacts at the region 170b and at least five constituent ring contacts at the region 170a.

### Examples of Robot Systems

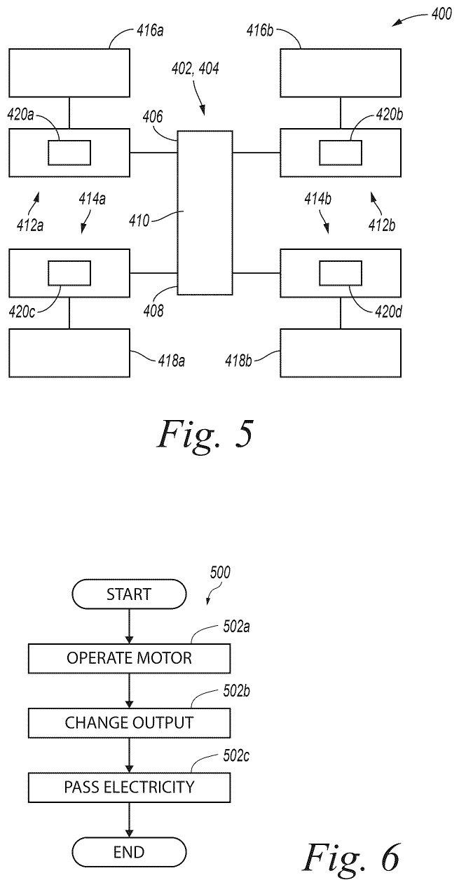

FIG. 5 is a block diagram corresponding to a mobile robot 400 including an actuator assembly in accordance with at least some embodiments of the present technology. In at least some cases, the mobile robot 400 includes structures resembling human anatomy with respect to the features, positions, and/or other characteristics of such structures. In these and other cases, the mobile robot 400 can define a midsagittal plane about which the mobile robot 400 is bilaterally symmetrical. Furthermore, the mobile robot 400 can be configured for bipedal locomotion similar to that of a human. Counterparts of the mobile robot 400 can have other suitable forms and features. For example, a counterpart of the mobile robot 400 can have a non-humanoid form, such as a canine form, an insectoid form, an arachnoid form, or a form with no animal analog. Still further, a counterpart of the mobile robot 400 can be asymmetrical or have symmetry other than bilateral. Also, a counterpart of the mobile robot 400 can be configured for non-bipedal locomotion. For example, a counterpart of the mobile robot 400 can be configured for another type of legged locomotion (e.g., quadrupedal locomotion, octopedal locomotion, etc.) and/or non-legged locomotion (e.g., wheeled locomotion, continuous-track locomotion, etc.).

The mobile robot 400 can include a centrally disposed body 402 through which other structures of the mobile robot 400 are interconnected. As all or a portion of the body 402, the mobile robot 400 can include a torso 404 having a superior portion 406, an inferior portion 408, and an intermediate portion 410 therebetween. The mobile robot 400 can further include articulated appendages carried by the torso 404. Among these articulated appendages, the mobile robot 400 can include arms 412a, 412b and legs 414a, 414b. In at least some cases, the mobile robot 400 is configured to manipulate objects via the arms 412a, 412b, such as bimanually. In these and other cases, the mobile robot 400 can be configured to ambulate via the legs 414a, 414b, such as bipedally. The arms 412a, 412b and the legs 414a, 414b can define kinematic chains. The kinematic chains corresponding to the arms 412a, 412b, for example, can provide at least five degrees of freedom, such as exactly five or exactly six degrees of freedom. In these and other cases, the kinematic chains corresponding to the legs 414a, 414b can provide at least four degrees of freedom, such as exactly four, exactly five, or exactly six degrees of freedom. As parts of the arms 412a, 412b, the mobile robot 400 can include end effectors 416a, 416b at distalmost portions of the corresponding kinematic chains. Similarly, as parts of the legs 414a, 414b, the mobile robot 400 can include feet 418a, 418b at distalmost portions of the corresponding kinematic chains.

At proximal ends and/or at other suitable points along the kinematic chains corresponding to the arms 412a, 412b and legs 414a, 414b, the mobile robot 400 can include respective joints (not shown). The mobile robot 400 can further include actuators 420 (individually identified as actuators 420a-420d) configured to cause motion at corresponding joints. The actuators 420a-420d can be adjacent to a corresponding joint or be connected to a corresponding joint in another suitable manner (e.g., via a connecting rod, a cable, etc.). In the illustrated embodiment, the actuator 420a is a component of the arm 412a, the actuator 420b is a component of the arm 412b, the actuator 420c is a component of the leg 414a, and the actuator 420d is a component of the leg 414b. In other embodiments, one or more of the actuators 420a-420d can be a component of the body 402.

In the illustrated and in other embodiments, at least one of the actuators 420a-420d and associated components of the mobile robot 400 can correspond to the actuator assembly 100 or another actuator assembly in accordance with at least some embodiments of the present technology. For example, the mobile robot 400 can include an actuator assembly with features in accordance with at least some embodiments of the present technology as the actuator 420a and operably associated with a shoulder joint, an elbow joint, or a wrist joint of the arm 412a. As another example, the mobile robot 400 can include an actuator assembly with features in accordance with at least some embodiments of the present technology as the actuator 420b and operably associated with a shoulder joint, an elbow joint, or a wrist joint of the arm 412b. As another example, the mobile robot 400 can include an actuator assembly with features in accordance with at least some embodiments of the present technology as the actuator 420c and operably associated with a hip joint, a knee joint, or an ankle joint of the leg 414a. As another example, the mobile robot 400 can include an actuator assembly with features in accordance with at least some embodiments of the present technology as the actuator 420d and operably associated with a hip joint, a knee joint, or an ankle joint of the leg 414b. Actuator assemblies in accordance with at least some embodiments of the present technology can be useful in many other locations in addition or alternatively. Furthermore, the mobile robot 400 is merely one example of a system in which features of at least some embodiments of the present technology can be implemented.

### Examples of Methods

FIG. 6 is a block diagram corresponding to a method 500 in accordance with at least some embodiments of the present technology. Although the method 500 will be described primarily in the context of the actuator assembly 100, it should be understood that suitable features of the method 500 can likewise be practiced in the contexts of another actuator assembly in accordance with at least some embodiments of the present technology. With reference to FIGS. 1-6 together, the method 500 can include operating the motor 150 (block 502a). This can include rotating the rotor 158 relative to the stator 156 about the axis 102. The method 500 can further include changing an output of the motor 150 (e.g., by decreasing the speed and increasing the torque) via the gearing 152 (block 502b). In connection with changing the output of the motor 150, the method 500 can include transferring torque from the rotor 158 to the shaft 154. Finally, the method 600 can include passing electricity through sliding interfaces at the ring assembly 112 (block 502c). Alternatively or in addition, the method 500 can include passing electricity through rolling interfaces at a counterpart of the ring assembly 112. This can be while a plane perpendicular to the axis 102 extends through the annular gap 160 and through a given one of the sliding or rolling interfaces.

### Conclusion

This disclosure is not intended to be exhaustive or to limit the present technology to the precise forms disclosed herein. Although specific embodiments are disclosed herein for illustrative purposes, various equivalent modifications are possible without deviating from the present technology, as those of ordinary skill in the relevant art will recognize. In some cases, well-known structures and functions have not been shown or described in detail to avoid unnecessarily obscuring the description of the embodiments of the present technology. Although steps of methods may be presented herein in a particular order, in alternative embodiments the steps may have another suitable order. Similarly, certain aspects of the present technology disclosed in the context of particular embodiments can be combined or eliminated in other embodiments. Furthermore, while advantages associated with certain embodiments may be disclosed herein in the context of those embodiments, other embodiments may also exhibit such advantages, and not all embodiments need necessarily exhibit such advantages or other advantages disclosed herein to fall within the scope of the present technology. This disclosure and the associated technology can encompass other embodiments not expressly shown or described herein.

Throughout this disclosure, the singular terms “a,” “an,” and “the” include plural referents unless the context clearly indicates otherwise. Similarly, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. As used herein, the terms “generally,” “substantially,” “about,” and similar terms are used as terms of approximation and not as terms of degree, and are intended to account for the inherent variations in measured or calculated values that would be recognized by those of ordinary skill in the art. Additionally, the terms “comprising,” “including,” “having,” and the like are used throughout this disclosure to mean including at least the recited feature(s) such that any greater number of the same feature(s) and/or one or more additional types of features are not precluded. This is the case even if a particular number of features is specified unless that specified number is preceded by the word “exactly” or another clear indication that it is intended to be closed ended. In a particular example, “comprising two arms” means including at least two arms. References herein to any of receiving, determining, or generating information in accordance with various embodiments of the present technology encompass, when feasible, the others of receiving, determining, and generating the information and indicate that such operations can occur at least partially via the relevant computing subsystem.

Directional terms, such as “upper,” “lower,” “front,” “back,” “vertical,” and “horizontal,” may be used herein to express and clarify the relationship between various structures. It should be understood that such terms do not denote absolute orientation. The term “centroid” as used herein refers to a center-like data element for a given shape in three-dimensional space. There are several known approaches to calculating centroids including approaches of greater and lesser precision. No particular approach is contemplated herein. Reference herein to “one embodiment,” “an embodiment,” or similar phrases means that a particular feature, structure, or operation described in connection with such phrases can be included in at least one embodiment of the present technology. Thus, such phrases as used herein are not all referring to the same embodiment. Unless preceded with the word “conventional,” reference herein to “counterpart” devices, systems, methods, features, structures, or operations refers to devices, systems, methods, features, structures, or operations in accordance with at least some embodiments of the present technology that are similar to a described device, system, method, feature, structure, or operation in certain respects and different in other respects. Finally, it should be noted that various particular features, structures, and operations of the embodiments described herein may be combined in any suitable manner in additional embodiments in accordance with the present technology.

I/We claim:

1. An actuator assembly comprising:
a motor including a rotor and a stator defining an annular gap therebetween, wherein the motor is configured to rotate the rotor relative to the stator about an axis;
gearing operably associated with the motor;
a ring assembly including:
ring contacts;
a first body carrying the ring contacts,
leads in series with the ring contacts,
a second body carrying the leads, and
connectors configured to provide electrical connections between the ring contacts and the leads, respectively, during relative rotation between the first and second bodies; and
a housing having:
a first end portion, and
a second end portion opposite to the first end portion along the axis,
wherein:
the actuator assembly defines a channel extending along the axis between the first and second end portions of the housing,
the ring assembly is at least partially disposed within the channel, and
a plane perpendicular to the axis extends through the annular gap and through a given one of the ring contacts.

2. The actuator assembly of claim 1, wherein the ring contacts extend circumferentially around the axis in different respective planes perpendicular to the axis.

3. The actuator assembly of claim 2, wherein the ring contacts include at least ten constituent ring contacts spaced apart from one another along the axis.

4. The actuator assembly of claim 2, wherein the connectors are brushes.

5. The actuator assembly of claim 2, wherein the connectors are rollers.

6. The actuator assembly of claim 1, further comprising:
first wiring at the first end portion of the housing; and
second wiring at the second end portion of the housing,
wherein the first wiring and the second wiring are electrically connected to one another via the ring assembly.

7. The actuator assembly of claim 1, wherein:
the actuator assembly defines:
a first plane perpendicular to the axis at the first end portion of the housing,
a second plane perpendicular to the axis at the second end portion of the housing, and
a third plane equidistant between the first and second planes,
a first region between the first and third planes, and
a second region between the second and third planes;
the gearing is at the first region of the actuator assembly; and
the rotor and the stator are at the second region of the actuator assembly.

8. The actuator assembly of claim 7, wherein the ring contacts include at least five constituent ring contacts at the first region of the actuator assembly.

9. The actuator assembly of claim 7, wherein the ring contacts include at least five constituent ring contacts at the second region of the actuator assembly.

10. The actuator assembly of claim 7, wherein:
the housing includes a tubular shaft defining the channel;
the ring assembly includes a case in which the ring contacts, the first body, the leads, the second body, and the connectors are disposed; and
the tubular shaft includes a ledge abutting the case at the first region of the actuator assembly.

11. The actuator assembly of claim 10, wherein:
the actuator assembly further comprises a spring abutting the case at the second region of the actuator assembly; and
the case is axially captured between the ledge and the spring.

12. The actuator assembly of claim 1, wherein the gearing is strain-wave gearing.

13. The actuator assembly of claim 1, wherein the gearing is cycloidal gearing.

14. A method comprising:
operating a motor of an actuator assembly, wherein the motor includes a rotor and a stator defining an annular gap therebetween, and wherein operating the motor includes rotating the rotor relative to the stator about an axis;
changing an output of the motor via gearing of the actuator assembly; and
passing electricity through interfaces at a ring assembly of the actuator assembly while a plane perpendicular to the axis extends through the annular gap and through a given one of the interfaces.

15. The method of claim 14, wherein:
during the method, the ring assembly includes:
ring contacts extending circumferentially around the axis in different respective planes perpendicular to the axis, and
brushes operably associated with the ring contacts; and
passing the electricity through the interfaces includes passing the electricity through sliding interfaces between the brushes and the ring contacts.

16. The method of claim 14, wherein:
during the method, the ring assembly includes:
ring contacts extending circumferentially around the axis in different respective planes perpendicular to the axis, and
rollers operably associated with the ring contacts; and
passing the electricity through the interfaces includes passing the electricity through rolling interfaces between the rollers and the ring contacts.

17. The method of claim 14, wherein, during the method:
the actuator assembly includes a housing having:
a first end portion, and
a second end portion opposite to the first end portion along the axis;
the actuator assembly defines a channel extending along the axis between the first and second end portions of the housing; and
the ring assembly is at least partially disposed within the channel.

18. The method of claim 17, wherein, during the method:
the actuator assembly defines:
a first plane perpendicular to the axis at the first end portion of the housing,
a second plane perpendicular to the axis at the second end portion of the housing, and
a third plane equidistant between the first and second planes,
a first region between the first and third planes, and
a second region between the second and third planes;
the gearing is at the first region of the actuator assembly; and
the rotor and the stator are at the second region of the actuator assembly.

19. The method of claim 18, wherein, during the method:
the housing includes a tubular shaft defining the channel;
the ring assembly includes a case in which the interfaces are disposed; and
the tubular shaft includes a ledge abutting the case at the second region of the actuator assembly.

20. The method of claim 19, wherein, during the method:
the actuator assembly further comprises a spring abutting the case at the first region of the actuator assembly; and
the method further comprises axially capturing the case between the ledge and the spring.
